(19) United States
(12) Patent Application Publication
(10) Pub. No.: US 2010/0034544 A1
(43) Pub. Date: Feb. 11, 2010

(54) METHOD OF RECOVERING FROM DUPLEX JAM FOR IMAGE FORMING APPARATUS AND THE IMAGE FORMING APPARATUS USING THE METHOD

(75) Inventor: Yun-su Kim, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/473,556

(22) Filed: May 28, 2009

(30) Foreign Application Priority Data
Aug. 8, 2008 (KR) 10-2008-0078193

(51) Int. Cl. G03G 15/00

(52) U.S. Cl. 399/21

(57) ABSTRACT

Provided are a method of recovering from a duplex jam for an image forming apparatus and the image forming apparatus using the method. The method includes sensing a paper jam on a duplex transport section, opening and closing the duplex printing unit if the paper jam is sensed, re-sensing the paper jam, and immediately resuming printing if the paper jam is not re-sensed. Thus, if a paper jam occurs during duplex printing by an image forming apparatus including a duplex printing unit, a recovery operation can be performed by merely eliminating the paper jammed on a duplex transport path without a need to open and close a main body cover, thereby continuing printing and thus providing convenience to a user by relieving a cumbersome process from the user and allowing the user to conveniently and promptly continuing printing.

### CROSS-REFERENCE TO RELATED APPLICATIONS

This application claims priority under 35 U.S.C. §119(a) from Korean Patent Application No. 10-2008-0078193, filed on Aug. 8, 2008, in the Korean Intellectual Property Office, the disclosure of which is incorporated herein in its entirety by reference.

### BACKGROUND

1. Field of the Invention

The present general inventive concept relates to an image forming apparatus, and more particularly, to a method of recovering from a duplex printing jam for an image forming apparatus and the image forming apparatus using the method.

2. Description of the Related Art

When a transport of a print paper is stopped due to jamming of the paper in a particular position on a transport path during operation of an image forming apparatus, the removal of the paper for enabling normal printing significantly affects the performance of the image forming apparatus.

According to a number of variables such as various thicknesses of print papers, feeding time intervals of print papers, and the like, the transport of a print paper may be stopped due to the jamming of the print paper in a particular position on a transport path, which is called a paper jam. In general, when the paper jam occurs, the image forming apparatus cannot continue printing and thus stops printing, and then indicates the occurrence of the paper jam through a user interface (UI) included in the image forming apparatus.

In the case of the occurrence of the paper jam during duplex (or double-sided) printing, the image forming apparatus continues printing after a series of processes. That is, a user, upon recognizing that the paper jam occurs on a duplex transport path, pulls out a duplex printing unit and removes the jammed paper. The user, after mounting the duplex printing unit back to the original position, opens a main body cover of the image forming apparatus and then closes the main body cover to continue printing. However, such processes of clearing the paper jam for allowing the image forming apparatus to operate normally are quite cumbersome for most users.

### SUMMARY

The present general inventive concept provides a method of recovering from a duplex jam for an image forming apparatus, in which the image forming apparatus can continue printing with minimized user intervention when a paper jam occurs, thereby providing convenience to a user.

Additional features and utilities of the present general inventive concept will be set forth in part in the description which follows and, in part, will be obvious from the description, or may be learned by practice of the general inventive concept.

The present general inventive concept also provides an image forming apparatus using the method.

Embodiments of the present general inventive concept provide a method of recovering from a duplex jam for an image forming apparatus comprising a duplex printing unit. The method may include sensing a paper jam on a duplex transport section, opening and closing the duplex printing unit if the paper jam is sensed, re-sensing the paper jam, and immediately resuming printing if the paper jam is not re-sensed.

Embodiments of the present general inventive concept, provide an image forming apparatus including at least one duplex jam sensor to sense a paper jam on a duplex transport section, a duplex printing unit sensor to detect whether a duplex printing unit is mounted or removed, a control unit to detect whether the duplex printing unit is opened and closed through the duplex printing unit sensor if the paper jam is sensed through the duplex jam sensor, to re-sense the paper jam, and to control a printing unit to resume printing if the paper jam is not re-sensed, and the printing unit to print upon receiving a print start command from the control unit.

Embodiments of the present general inventive concept provide a method of recovering from a duplex jam for an image forming apparatus comprising a duplex printing unit. The method may include sensing a paper jam on a duplex transport section, stopping printing if the paper jam is sensed, detecting whether the duplex printing unit is removed, detecting whether the duplex printing unit is mounted back if the paper jam is not detected when the duplex printing unit is removed, and immediately resuming printing if the duplex printing unit is mounted back.

Embodiments of the present general inventive concept provide an image forming apparatus including at least one duplex jam sensor to sense a paper jam on a duplex transport section, a duplex printing unit sensor to detect whether a duplex printing unit is mounted or removed, a control unit to stop printing if the paper jam is sensed through the duplex jam sensor, to detect whether the duplex printing unit is removed through the duplex printing unit sensor, to detect whether the duplex printing unit is mounted back if the paper jam is not sensed when the duplex printing unit is removed, and to control a printing unit to resume printing if the duplex printing unit is mounted back, and the printing unit to print upon receiving a print start command from the control unit.

Embodiments of the present general inventive concept provide a method of removing a duplex printer jam in a peripheral device with a duplex printing unit comprising sensing a printing medium jam on a duplex transport section; stopping printing upon occurrence of a printing medium jam; opening the duplex printing unit; removing the jammed printing medium; closing the duplex printing unit; re-sensing whether a printing medium jam on the duplex transport section remains; and continuing with printing if no printing medium jam was re-sensed.

Embodiments of the present general inventive concept provide a peripheral device with a duplex printing unit comprising at least one duplex printing jam sensor, connected to a control unit, to sense a printing medium jam along a longitudinal direction of a duplex transport section; the control unit to detect through a duplex printing unit sensor whether the duplex printing unit is opened or closed; the at least one duplex printing jam sensor to reactivate its sensor to sense whether a printing medium jam remains; and the control unit to activate printing by a printing unit if the duplex printing jam sensor fails to sense a printing medium jam.

Embodiments of the present general inventive concept provide a method of recovering from a duplex printing jam for an image forming apparatus having a duplex printing unit, the method comprising receiving a printing command and starting printing operation; determining if a paper jam is sensed; determining if the duplex printing unit is removed and mounted back after the detected paper jam; re-sensing if there is a paper jam after the mounting back of the duplex printing unit; performing a recovery operation if no jam has been sensed; and continuing the printing operation.

### BRIEF DESCRIPTION OF THE DRAWINGS

The above and other aspects and advantages of the present general inventive concept will become more apparent by describing in detail exemplary embodiments thereof with reference to the attached drawings in which:

FIG. 1 is a schematic diagram illustrating an image forming apparatus using a method of recovering from a duplex jam according to exemplary embodiments of the present general inventive concept;

FIG. 2 is a block diagram of an image forming apparatus according to exemplary embodiments of the present general inventive concept;

FIG. 3 is a flowchart illustrating a method of recovering from a duplex printing jam for an image forming apparatus according to the exemplary embodiments illustrated in FIG. 2 of the present general inventive concept;

FIG. 4 illustrates a duplex transport section where a paper jam occurs;

FIG. 5 is a flowchart illustrating an indication of a paper jam in a 1-transport type duplex printing method according to exemplary embodiments of the present general inventive concept;

FIG. 6 is a flowchart illustrating indication of a paper jam in a 2-transport type duplex printing method according to exemplary embodiments of the present general inventive concept;

FIG. 7 is a block diagram of an image forming apparatus according to exemplary embodiments of the present general inventive concept; and

FIG. 8 is a flowchart illustrating a method of recovering from a duplex printing jam for an image forming apparatus according to the exemplary embodiment illustrated in FIG. 7 of the present general inventive concept.

### DETAILED DESCRIPTION OF THE EMBODIMENTS

The present general inventive concept will now be described more fully with reference to the accompanying drawings, in which exemplary embodiments of the present general inventive concept are illustrated.

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

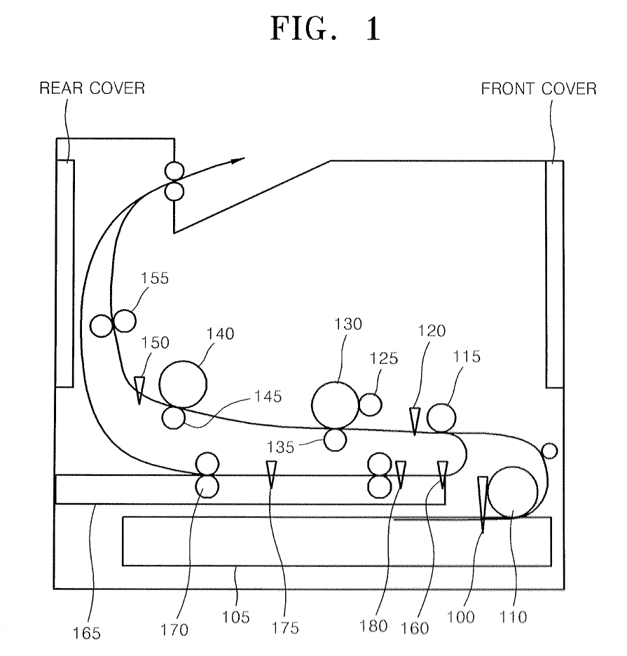

In general, an image forming apparatus such as a printer or a copy machine may include a paper sensor 100, a pickup roller 110, a feed sensor 120, a developing roller 125, a transfer roller 135, a fusing roller 140 and a pressing roller 145, an ejecting sensor 150, and an ejecting roller 155, as illustrated in FIG. 1. A paper loaded in a tray 105 can be sensed by the paper sensor 100. Upon input of a print command, the pickup roller 110 picks up the paper. The feed sensor 120 can sense the paper transported from the pickup roller 110 via a transport roller 115. After a front end of the paper passes by the feed sensor 120, the transfer roller 135 can transfer a toner of an organic photo conductor (OPC) drum 130, which has been developed by a developing roller 125, onto the paper. The fusing roller 140 and the pressing roller 145 can fuse the toner onto the transferred paper. The ejecting sensor 150 can determine whether the paper arrives at an ejecting unit. The ejecting roller 155 can eject the paper.

The image forming apparatus may include a duplex roller 170 and duplex jam sensors 175 and 180. Upon input of a duplex (or double-sided) print command, the duplex roller 170 can determine, by using a duplex printing unit sensor 160, whether a duplex printing unit 165 is mounted to transport the paper. The duplex jam sensors 175 and 180 can sense the paper on a duplex transport path. These rollers (110, 115, 125, 135, 140, 145, 155, 170) can be connected to a gear and other power transmission means through a drive motor.

In a warm-up stage for printing, the image forming apparatus may perform a preheating process by heating a heat roller (not illustrated) to a predetermined temperature upon the generation of heat by a heat source, driving the drive motor to rotate the transfer roller 135 and the fusing roller 140, and removing the remaining toner upon the completion of printing. In other words, the image forming apparatus can drive the transport roller 115 to transport a print paper along a transport path including the developing roller 125, the transfer roller 135, the fusing roller 140, the pressing roller 145, and the duplex roller 170, and can print print data through a series of processes including development, transfer, and fusing. Thus, the transfer roller 135, the developing roller 125, the heat roller, the pressing roller 145, and the duplex roller 170 of the image forming apparatus can be installed in such a way that they allow the paper to be smoothly transported without applying excessive pressure to the paper.

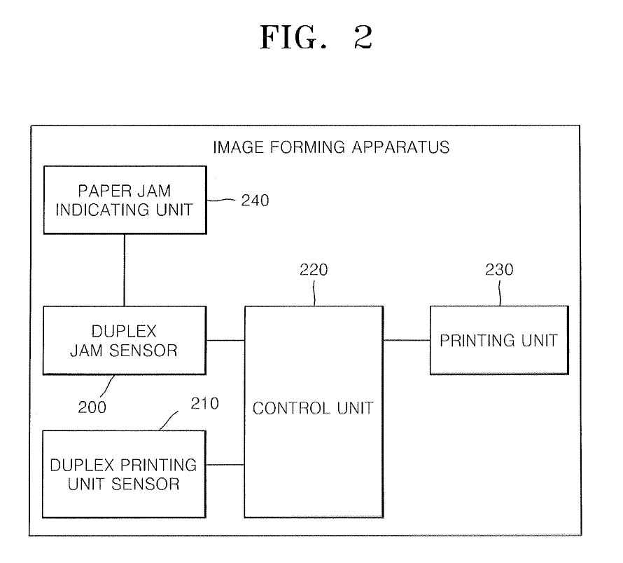

FIG. 2 is a block diagram of an image forming apparatus using a method of recovering from a duplex printing jam according to an exemplary embodiment of the present general inventive concept.

Referring to FIG. 2, the image forming apparatus may include a duplex jam sensor 200, a duplex printing unit sensor 210, a control unit 220, a printing unit 230, and a paper jam indicating unit 240. The duplex jam sensor 200 may sense a paper jam occurring on a duplex transport section.

The duplex jam sensor 200 may include two duplex jam sensor units that can be installed in a front portion and a rear portion, respectively, along a longitudinal direction in which a paper is loaded in a duplex printing unit. The duplex jam sensor 200 may sense a paper jam occurring on the duplex transport section through one of the two duplex jam sensor units. The duplex printing unit sensor 210 can detect whether the duplex printing unit is mounted or removed.

Once a paper jam is sensed by the duplex jam sensor 200, the control unit 220 can detect through the duplex printing unit sensor 210 whether the duplex printing unit is opened and then closed and re-senses through the duplex jam sensor 200 the paper jam to control the printing unit 250 to immediately resume printing if the paper jam is not detected. In other words, if the duplex printing unit is mounted back, the control unit 220 can control the printing unit 250 to resume printing without a need to open and then close a cover of the image forming apparatus.

The paper jam indicating unit 240 can indicate the paper jam if the paper jam is sensed by the duplex jam sensor 200.

The printing unit 230, upon receiving a print start command from the control unit 220, performs the printing.

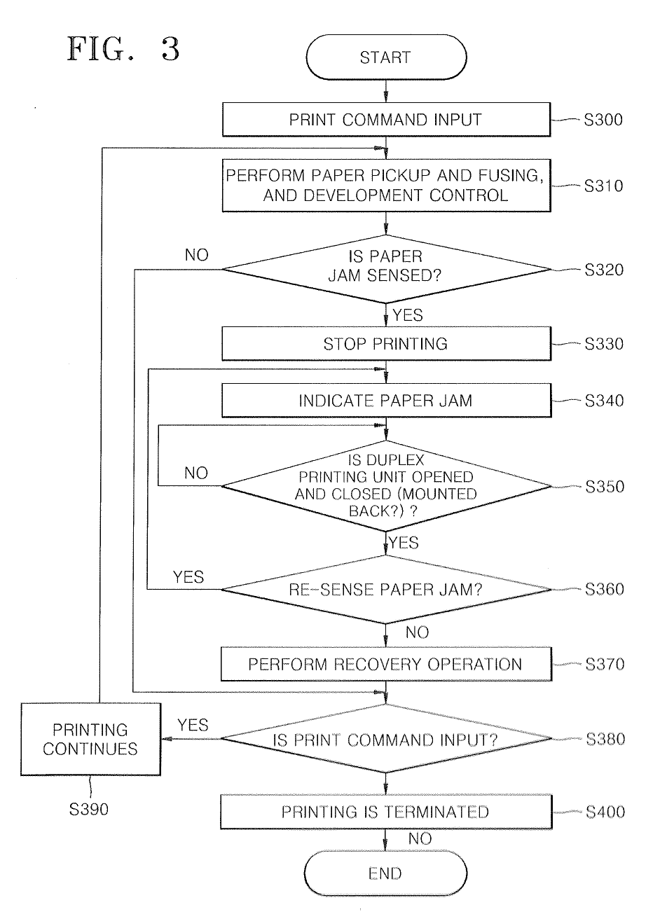

FIG. 3 is a flowchart illustrating a method of recovering from a duplex printing jam for an image forming apparatus according to the exemplary embodiment of FIG. 2 of the present general inventive concept.

Upon input of a print command in operation S300, a motor is driven to perform paper pickup and fusing and development control in operation S310. It is determined whether the duplex jam sensor 200 senses a paper jam on a duplex transport section during duplex printing in operation S320.

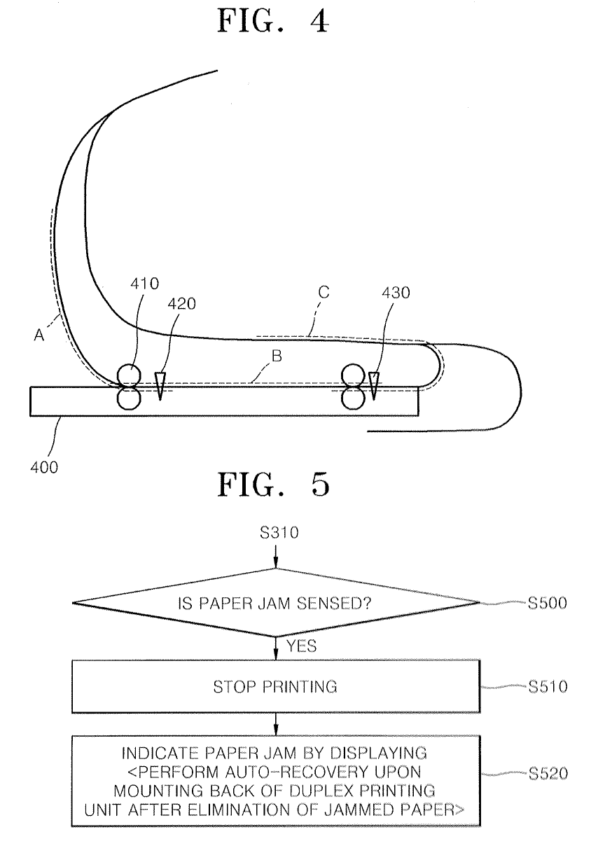

To determine whether a paper jam occurs on the duplex transport section, a first duplex jam sensor unit 420 and a second duplex jam sensor unit 430 as illustrated in FIG. 4 may be used. If the paper jam is sensed by one of the first duplex jam sensor unit 420 and the second duplex jam sensor unit 430, a jammed paper can be easily eliminated after removing a duplex printing unit 400. The duplex transport section may be divided into three sub-sections, i.e., a sub-section A, a sub-section B, and a sub-section C as illustrated in FIG. 4.

A paper, after entering the duplex printing unit 400, can pass by a duplex roller 410 and then the first duplex jam sensor unit 420. However, if the paper does not move in this way, a paper jam occurring on the sub-section A can be sensed and thus printing may be stopped.

If the paper, after entering the duplex printing unit 400, passes by the first duplex jam sensor unit 420, but fails to pass by the second duplex jam sensor unit 430, a paper jam occurring on the sub-section B can be sensed and thus printing may be stopped.

If the paper, after entering the duplex printing unit 400, passes by both the first duplex jam sensor unit 420 and the second duplex jam sensor unit 430, but a rear end of the paper fails to completely get out of the second duplex jam sensor unit 430, a paper jam occurring on the sub-section C can be sensed and thus printing may be stopped.

Referring back to FIG. 3, if the paper jam is sensed in operation S320, printing can be stopped in operation S330 and the paper jam may be indicated on a user interface (UI) screen or other display devices in operation S340.

A user can remove the duplex printing unit to eliminate the paper jammed on the duplex transport section. It is checked whether the duplex printing unit is mounted back in operation S350.

If the duplex printing unit is mounted back, the paper jam can be re-sensed in operation S360.

If the paper jam is not detected, a recovery operation can be performed on the image forming apparatus by recovering the image forming apparatus to a printable state in operation S370. In other words, if the duplex printing unit is mounted back, the recovery operation can be performed to switch the printing unit to an initial state and a pre-heating operation can be performed, thereby stabilizing the image forming apparatus.

Upon the completion of the recovery operation, it may be determined whether the print command is input in operation S380. Thus, printing may continue in operation S390 if the print command is input, and printing is terminated in operation S400 if the print command is not input. The image forming apparatus having the duplex printing unit may use two duplex printing methods according to its mechanical structure and specifications.

One of the two duplex printing methods is of a 1-transport type in which only 1 paper is transported on a transport section of the image forming apparatus and a next paper is picked up after the completion of duplex printing of the transported paper.

FIG. 5 is a flowchart illustrating indication of a paper jam in the 1-transport type duplex printing method. Referring to FIG. 5, if a paper jam is sensed on a duplex transport section during duplex printing by the image forming apparatus using the 1-transport type duplex printing method in operation S500, printing can be stopped in operation S510. At this time, since only 1 paper is on the duplex transport section, a recovery operation can be easily performed by removing a jammed paper and then mounting back the duplex printing unit. If the paper jam occurs, the paper jam can be indicated by displaying <Recovery is automatically performed upon Mounting back of Duplex Printing Unit after Elimination of Jammed Paper> on a user interface (UI) screen in operation S520, or any other suitable message.

The other of the two duplex printing methods is of a 2-transport type in which 2 papers are transported on the transport section of the image forming apparatus and the next one between the 2 papers can be picked up while the previous one is on the duplex transport section.

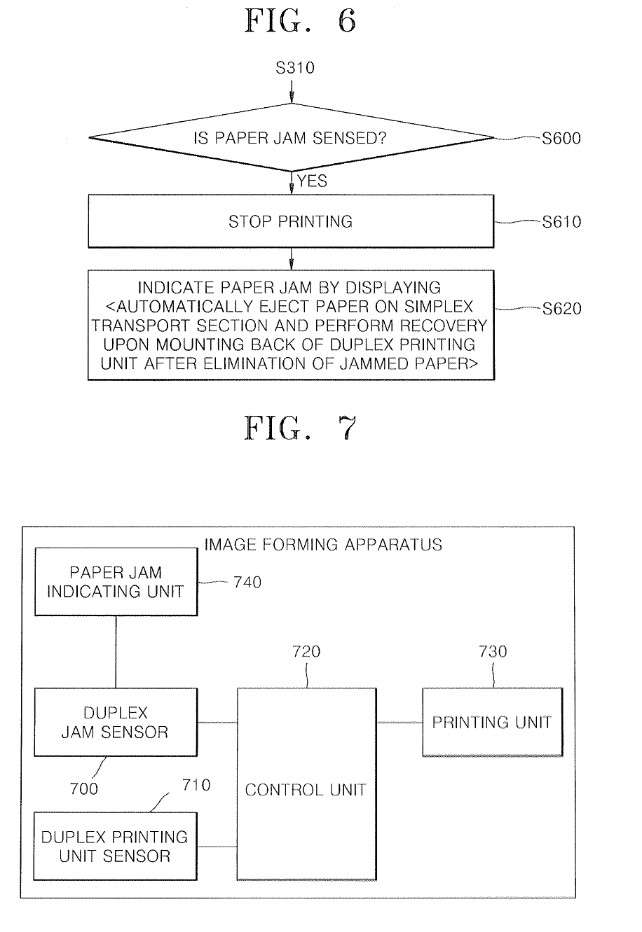

FIG. 6 is a flowchart illustrating indication of a paper jam in the 2-transport type duplex printing method. Referring to FIG. 6, if a paper jam is sensed on a duplex transport section during duplex printing by the image forming apparatus using the 2-transport type duplex printing method in operation S600, printing is stopped in operation S610. At this time, 2 or more papers can be jammed on a simplex transport section as well as the duplex transport section, i.e., on both a feed section and an eject section. In this case, in an image forming apparatus capable of auto ejection, the paper jammed on the simplex transport section can be automatically ejected by merely mounting the duplex printing unit back after elimination of the paper jammed on the duplex transport section, thereby easily performing a recovery operation. If the paper jam occurs, the paper jam can be indicated by displaying <Automatically Eject Paper and Perform Recovery on Simplex Transport Section upon Mounting back of Duplex Printing Unit after Elimination of Jammed Paper> on a UI screen in operation S620, or any other suitable message.

An image forming apparatus according to an exemplary embodiment of the present general inventive concept is different from that according to the exemplary embodiment of FIG. 2 in terms of control performed by the control unit 220.

FIG. 7 is a block diagram of the image forming apparatus according to an exemplary embodiment of the present general inventive concept.

Referring to FIG. 7, the image forming apparatus may include a duplex jam sensor 700, a duplex printing unit sensor 710, a control unit 720, a printing unit 730, and a paper jam indicating unit 740. The duplex jam sensor 700 can sense a paper jam occurring on a duplex transport section.

The duplex jam sensor 700 may include two duplex jam sensor units that are installed in a front portion and a rear portion, respectively, along a longitudinal direction in which a paper is loaded in a duplex printing unit. The duplex jam sensor 700 may sense a paper jam occurring on the duplex transport section through one of the two duplex jam sensor units. The duplex printing unit sensor 710 can detect whether the duplex printing unit is mounted or removed.

Once the paper jam is sensed by the duplex jam sensor 700, the control unit 720 may stop printing, may detect through the duplex printing unit sensor 710 whether the duplex printing unit is removed, may detect whether the duplex printing unit is mounted back if the paper jam is not sensed when the duplex printing unit is removed, and may control the printing unit 250 to immediately resume printing if the duplex printing unit is mounted back. In other words, if the duplex printing unit is mounted back, the control unit 720 may control the printing unit 250 to start resume printing without a need to open and then close the cover of the image forming apparatus.

The paper jam indicating unit 740 can indicate the paper jam if the paper jam is sensed by the duplex jam sensor 700.

The printing unit 730, upon receiving a print start command from the control unit 720, can perform the printing.

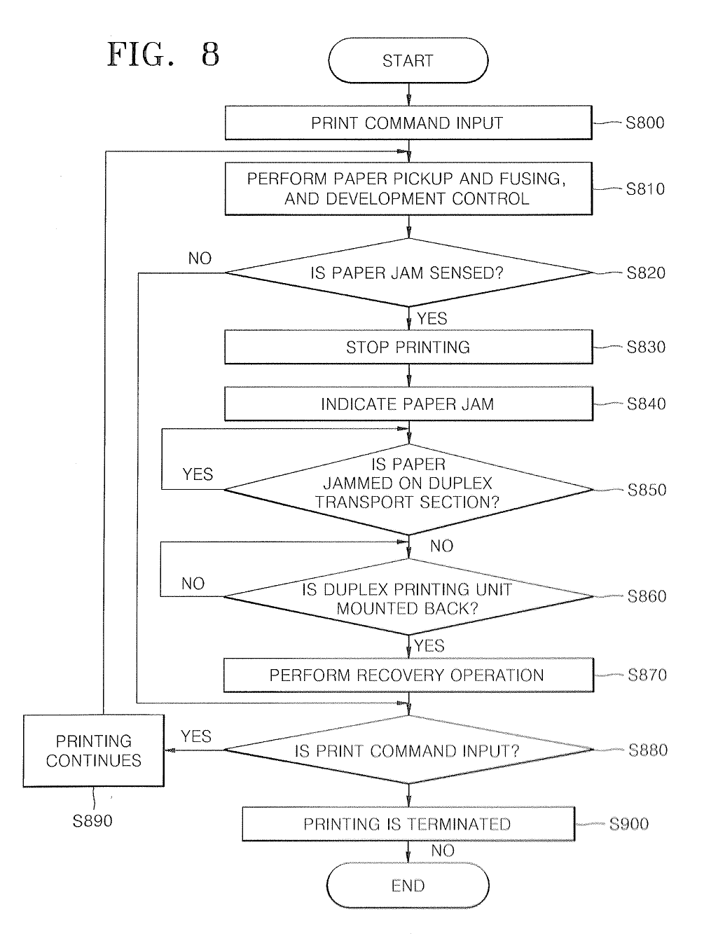

FIG. 8 is a flowchart illustrating a method of recovering from a duplex jam for an image forming apparatus according to the exemplary embodiment of FIG. 7 of the present general inventive concept.

Upon input of a print command in operation S800, a motor can be driven to perform paper pickup and fusing and development control in operation S810. It can be determined whether the duplex jam sensor 800 senses a paper jam on a duplex transport section during duplex printing in operation S820.

To determine whether a paper jam occurs on the duplex transport section, the first duplex jam sensor unit 420 and the second duplex jam sensor unit 430 as illustrated in FIG. 4 may be used like in the exemplary embodiment of FIG. 2. If the paper jam is sensed by one of the first duplex jam sensor unit 420 and the second duplex jam sensor unit 430, a jammed paper can be easily eliminated after removing the duplex printing unit 400. The duplex transport section may be divided into three sub-sections, i.e., a sub-section A, a sub-section B, and a sub-section C as illustrated in FIG. 4.

A paper, after entering the duplex printing unit 400, passes by a duplex roller 410 and then the first duplex jam sensor unit 420. However, if the paper does not move in this way, a paper jam occurring on the sub-section A can be sensed, and thus printing can be stopped.

If the paper, after entering the duplex printing unit 400, passes by the first duplex jam sensor unit 420, but fails to pass by the second duplex jam sensor unit 430, a paper jam occurring on the sub-section B can be sensed, and thus printing can be stopped.

If the paper, after entering the duplex printing unit 400, passes by both the first duplex jam sensor unit 420 and the second duplex jam sensor unit 430, but a rear end of the paper fails to completely get out of the second duplex jam sensor unit 430, a paper jam occurring on the sub-section C can be sensed, and thus printing can be stopped.

If the paper jam is sensed in operation S820, printing is stopped in operation S830 and the paper jam can be indicated on a UI screen or other display devices in operation S840.

After a user removes the duplex printing unit, it can be determined through the duplex jam sensor 700 whether the paper is jammed on the duplex transport section in operation S850.

After the paper jammed on the duplex transport section is eliminated, i.e., when there is no jammed paper on the duplex transport section, it can be determined through the duplex printing unit sensor 710 whether the duplex printing unit can be mounted back in operation S860.

If the duplex printing unit is mounted back, a recovery operation can be performed on the image forming apparatus by recovering the image forming apparatus to a printable state in operation S870. In other words, if the duplex printing unit is mounted back, the recovery operation can be performed to switch the printing unit to an initial state and a pre-heating operation can be performed, thereby stabilizing the image forming apparatus.

Upon the completion of the recovery operation, it can be determined whether the print command is input in operation S880. Thus, printing can continue in operation S890 if the print command is input, and printing is terminated in operation S900 if the print command is not input.

In the exemplary embodiment illustrated in FIG. 7, like in the exemplary embodiment illustrated in FIG. 2, the image forming apparatus having the duplex printing unit may use two duplex printing methods according to its mechanical structure and specifications. Indication of a paper jam in the 1-transport type duplex printing method and the 2-transport type duplex printing method can also be performed as illustrated in FIGS. 5 and 6 according to the exemplary embodiment illustrated in FIG. 2. Therefore, a related description will not be provided again.

According to the present general inventive concept, if a paper jam occurs during duplex printing by an image forming apparatus including a duplex printing unit, a recovery operation can be performed by merely eliminating the paper jammed on a duplex transport path without a need to open and then close a main body cover, thereby continuing printing and thus providing convenience to a user by relieving a cumbersome process from the user and allowing the user to conveniently and promptly continuing printing.

While the present general inventive concept has been particularly illustrated and described with reference to exemplary embodiments thereof, it will be understood by those of ordinary skill in the art that various changes in form and details may be made therein without departing from the spirit and scope of the present general inventive concept as defined by the following claims.

What is claimed is:

1. A method of recovering from a duplex printing jam for an image forming apparatus comprising a duplex printing unit, the method comprising:
sensing a paper jam on a duplex transport section;
opening and closing the duplex printing unit if the paper jam is sensed;
re-sensing the paper jam; and
immediately resuming printing if the paper jam is not re-sensed.

2. The method of claim 1, wherein the sensing of the paper jam comprises:
sensing the paper jam by using at least one sensor on the duplex printing unit.

3. The method of claim 1, wherein the opening and closing of the duplex printing unit comprises:
eliminating the jammed paper.

4. The method of claim 1, wherein the resuming of the printing comprises:
starting printing without opening and closing a cover of the image forming apparatus, if the duplex printing unit is mounted back.

5. The method of claim 1, further comprising:
indicating the paper jam if the paper jam is sensed.

6. The method of claim 5, wherein the indication of the paper jam comprises:
indicating that printing is resumed if the duplex printing unit is mounted back after elimination of the jammed paper.

7. The method of claim 5, wherein the indication of the paper jam comprises:
indicating that printing is resumed, if a paper on a simplex transport section is ejected by mounting the duplex printing unit back after elimination of a jammed paper.

8. An image forming apparatus comprising:
at least one duplex jam sensor to sense a paper jam on a duplex transport section;
a duplex printing unit sensor to detect whether a duplex printing unit is mounted or removed;
a control unit to detect whether the duplex printing unit is opened and closed through the duplex printing unit sensor if the paper jam is sensed through the duplex jam sensor, to re-sense the paper jam, and to control a printing unit to resume printing if the paper jam is not re-sensed; and
the printing unit to print upon receiving a print start command from the control unit.

9. The image forming apparatus of claim 8, further comprising:
a paper jam indicating unit to indicate the paper jam if the paper jam is sensed through the duplex jam sensor.

10. The image forming apparatus of claim 8, wherein the control unit controls the printing unit to resume printing without opening and closing of the image forming apparatus if the duplex printing unit is mounted.

11. A method of recovering from a duplex printing jam for an image forming apparatus comprising a duplex printing unit, the method comprising:
sensing a paper jam on a duplex transport section;
stopping printing if the paper jam is sensed;
detecting whether the duplex printing unit is removed;
detecting whether the duplex printing unit is mounted back if the paper jam is not detected when the duplex printing unit is removed; and
immediately resuming printing if the duplex printing unit is mounted back.

12. The method of claim 11, wherein the sensing the paper jam on the duplex transport section comprises:
sensing the paper jam by using at least one sensor on the duplex printing unit.

13. The method of claim 11, wherein the immediate resuming the printing if the duplex printing unit is mounted back comprises:
immediately resuming printing without opening and closing a cover of the image forming apparatus, if the duplex printing unit is mounted.

14. The method of claim 11, further comprising:
indicating the paper jam if the paper jam is sensed.

15. The method of claim 14, wherein the indication of the paperjam comprises:
indicating that printing is resumed if the duplex printing unit is mounted back after elimination of the jammed paper.

16. The method of claim 14, wherein the indication of the paperjam comprises:
indicating that printing is resumed if a paper on a simplex transport section is ejected by mounting the duplex printing unit back after elimination of the jammed paper.

17. An image forming apparatus comprising:
at least one duplex jam sensor to sense a paper jam on a duplex transport section;
a duplex printing unit sensor to detect whether a duplex printing unit is mounted or removed;
a control unit to stop printing if the paper jam is sensed through the duplex jam sensor, to detect whether the duplex printing unit is removed through the duplex printing unit sensor, to detect whether the duplex printing unit is mounted back if the paper jam is not sensed when the duplex printing unit is removed, and to control a printing unit to resume printing if the duplex printing unit is mounted back; and
the printing unit to print upon receiving a print start command from the control unit.

18. The image forming apparatus of claim 17, further comprising:
a paper jam indicating unit to indicate the paper jam if the paper jam is sensed through the duplex jam sensor.

19. The image forming apparatus of claim 17, wherein the control unit controls the printing unit to resume printing without opening and closing of the image forming apparatus if the duplex printing unit is mounted.

20. A method of removing a duplex printer jam in a peripheral device with a duplex printing unit comprising:
sensing a printing medium jam on a duplex transport section;
stopping printing upon occurrence of a printing medium jam;
opening the duplex printing unit;
removing the jammed printing medium;
closing the duplex printing unit;
re-sensing whether a printing medium jam on the duplex transport section remains; and
continuing with printing if no printing medium jam was re-sensed.
